(19) United States
(12) Patent Application Publication
(10) Pub. No.: US 2006/0269795 A1
(43) Pub. Date: Nov. 30, 2006

(54) Magnetic recording media

(75) Inventors: Yoshitaka Yanagita, Tokyo (JP); Hiroyuki Hieda, Yokohama-shi (JP); Katsuyuki Naito, Tokyo (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/441,340

(22) Filed: May 26, 2006

(30) Foreign Application Priority Data
May 26, 2005 (JP) 2005-153827

(51) Int. Cl. G11B 5/65; B05D 5/12

(52) U.S. Cl. 428/833; 428/833.1; 428/833.5; 428/836; 427/127

(57) ABSTRACT

A magnetic recording media has a magnetic recording layer including recording track regions including recording cells of magnetic dots arrayed in a down-track direction and forming plural rows in a cross-track direction, and a nonmagnetic layer filled in recesses between the recording cells, and separation regions of a nonmagnetic layer, separating the recording track regions, and a lubricant applied to a surface of the magnetic recording layer, in which grooves are formed on a surface of the nonmagnetic layer in the separation regions so as to be recessed by 2 to 10 nm with respect to a surface of the nonmagnetic layer in the recording track regions, and in which the lubricant is applied to the surface of the magnetic recording layer so as to be filled in the grooves.

### CROSS-REFERENCE TO RELATED APPLICATIONS

This application is based upon and claims the benefit of priority from prior Japanese Patent Application No. 2005-153827, filed May 26, 2005, the entire contents of which are incorporated herein by reference.

### BACKGROUND OF THE INVENTION

1. Field of the Invention

The present invention relates to a magnetic recording media classified into a so-called patterned media, and to a magnetic recording apparatus provided with the magnetic recording media.

2. Description of the Related Art

Since the invention of magnetic recording apparatus, the increase tendency of recording density has been continued year by year, and the storage capacity of an auxiliary storage installed in a computer has been increased accompanying the increase in the recording density.

In magnetic recording, there is a concern that thermal fluctuation limits recording, making it impossible to write at a certain recording density or higher. In order to avoid this problem, in the magnetic recording field, a patterned media has been proposed in which a recording material is separated with a non-recording material in advance to form dot-like recording cells to which read and write are carried out.

The patterned media can achieve a high density by separating the magnetic material with the nonmagnetic material so as to isolate the recording cells. In the case where the same recording material is used, the patterned media, with the isolated recording cells formed by separating the magnetic material with the nonmagnetic material, can maintain higher thermal stability and has a higher coercivity relative to a magnetic field causing magnetization reversal, compared to a conventional magnetic recording media (see, for example, S. Y. Chou et al., J. Appl. Phys., 76 (1994) pp. 6673-6675; R. H. M. New et al., J. Vac. Sci. Technol., B12 (1994) pp. 3196-3201).

In addition, various structures of recording material and non-recording material in the patterned media and various manufacturing methods for forming such structures have been proposed (see, for example, Jpn. Pat. Appln. KOKAI No. 2001-110050).

In the case where a patterned media is installed in a magnetic recording apparatus and a magnetic head is made to fly, head crash tends to occur if unevenness is formed on the surface of the pattern media due to dot-like recording cells. For example, if a head with a flying height (FH) of 30 nm is made to fly over a patterned media in which recording cells composed of cylindrical magnetic dots with a diameter of 20 nm and a height of 20 nm are arrayed, the head may contact the media to cause head crash within a period of several minutes to several tens of minutes. Also, a head with a flying height (FH) of 15 nm may cause head crash even more easily. Even if head crash does not occur, flying instability is brought about when the head contacts the surface of the patterned media, which leads to intense vibration of the head or causes a phenomenon that the head shaves off a part of the media.

On the other hand, if a nonmagnetic layer is filled in between dot-like recording cells so as to form a flattened surface with a surface roughness (Ra) of 0.5 nm or less and then a lubricant is applied to the surface thereof, the head tends to cause stiction to the media, leading to flying instability. This is because when the head contacts the media, a sticking force by the lubricant is exerted between the head and the media. When the head has stuck to the media in this manner, head crash is caused as well as the media is damaged.

### BRIEF SUMMARY OF THE INVENTION

A magnetic recording media according to an aspect of the present invention comprises: a magnetic recording layer comprising: recording track regions including recording cells of magnetic dots arrayed in a down-track direction and forming plural rows in a cross-track direction, and a nonmagnetic layer filled in recesses between the recording cells, and separation regions of a nonmagnetic layer, separating the recording track regions; and a lubricant applied to a surface of the magnetic recording layer, wherein grooves are formed on a surface of the nonmagnetic layer in the separation regions so as to be recessed by 2 to 10 nm with respect to a surface of the nonmagnetic layer in the recording track regions, and wherein the lubricant is applied to the surface of the magnetic recording layer so as to be filled in the grooves.

A method of manufacturing a magnetic recording media according to another aspect of the present invention comprises: depositing a magnetic layer on a substrate; patterning the magnetic layer into magnetic dots to form recording cells arrayed in a down-track direction and forming plural rows in a cross-track direction so as to form recording track regions; coating the substrate with a precursor solution of a nonmagnetic layer so as to be filled in recesses between the recording cells and separation regions between recording track regions; annealing the precursor solution to form the nonmagnetic layer having grooves on a surface thereof in the separation regions which are recessed by 2 to 10 nm with respect to a surface thereof in the recording track regions so as to form a magnetic recording layer; and applying a lubricant to a surface of the magnetic recording layer so as to be filled in the grooves.

### BRIEF DESCRIPTION OF THE SEVERAL VIEWS OF THE DRAWING

FIG. 1 is a perspective view of a magnetic recording apparatus according to an embodiment of the present invention;

FIGS. 2A, 2B, 2C, 2D, 2E, 2F, 2G, 2H and 2I are cross-sectional views showing a method of manufacturing a patterned media according to the embodiment of the invention;

FIGS. 3A and 3B are a plan view of a stamper and a perspective view showing an imprinting method according to the embodiment of the invention, respectively;

FIGS. 4A, 4B and 4C are cross-sectional views showing the method of manufacturing a patterned media according to the embodiment of the invention; and

FIGS. 5A, 5B and 5C are cross-sectional views showing a method of manufacturing a patterned media of a comparative example.

### DETAILED DESCRIPTION OF THE INVENTION

A magnetic recording media according to an embodiment of the present invention is a so-called patterned media comprising: a magnetic recording layer comprising (a) recording track regions including recording cells of magnetic dots arrayed in a down-track direction and forming plural rows in a cross-track direction, and a nonmagnetic layer filled in recesses between the recording cells, and (b) separation regions separating the recording track regions and formed of a nonmagnetic layer; and a lubricant applied to the surface of the magnetic recording layer. In addition, grooves recessed by 2 to 10 nm with respect to a surface of the nonmagnetic layer in the recording track regions are formed on a surface of the nonmagnetic layer in the separation regions, and the lubricant is applied to the surface of the magnetic recording layer so as to be filled in the grooves.

The magnetic recording media according to the embodiment of the invention has such a surface that appropriate roughness is formed when the nonmagnetic layer is filled in the recesses between the recording cells. At this time, spin-on glass (SOG) may be used as a precursor material of the nonmagnetic layer. When the SOG solution is applied to the magnetic recording layer, the concentration and viscosity of the SOG solution, the rotating speed of a spin coater, and the thickness of the SOG left on the recording cell are adjusted appropriately. Thus, the depth of the grooves formed on the surface of the separation regions can be adjusted, making it possible to providing a media surface with appropriate roughness. In the patterned media whose surface has appropriate roughness, a head unlikely collides with the media, and also a reduced contact area of the head to the media prevents the head from sticking to the media. Consequently, even if the head contacts the media, only a little lubricant adheres to the head.

In the magnetic recording media according to the embodiment of the invention, the surface of the nonmagnetic layer in the recording track regions may have a height within a range between a position higher by 10 nm and a position lower by 5 nm with respect to the surface of the recording cells. That is, the nonmagnetic layer may be deposited on the recording cells up to a thickness of 10 nm. Conversely, the recording cells may protrude from the surface of the nonmagnetic layer up to 5 nm. In order to cause the recording cells to protrude from the surface of the nonmagnetic layer, the nonmagnetic layer is filled in recesses between the recording cells, and then the surface of the nonmagnetic layer is etched by ion milling using Ar gas or N₂ gas, reactive ion etching, or RF sputter etching. When the recording cell is caused to protrude appropriately from the surface of the nonmagnetic layer in this manner, the head can stably fly with a low flying height.

In the magnetic recording media according to the embodiment of the invention, the width of the separation region is preferably set to a range from 5 to 100 nm, and the ratio of the width of the recording track region to the width of the separation region is preferably set to a range from 10:1 to 1:1. When the width of the separation region is appropriately adjusted, the lubricant is collected in the grooves, which makes it possible to prevent the head from sticking to the media and brings about stable flying property.

The magnetic recording apparatus having the magnetic recording media according to the embodiment of the invention installed therein allows the head to fly stably with a low flying height and can provides good read/write (R/W) characteristics.

### EXAMPLES

Now, examples of the present invention will be described with reference to the drawings.

### Example 1

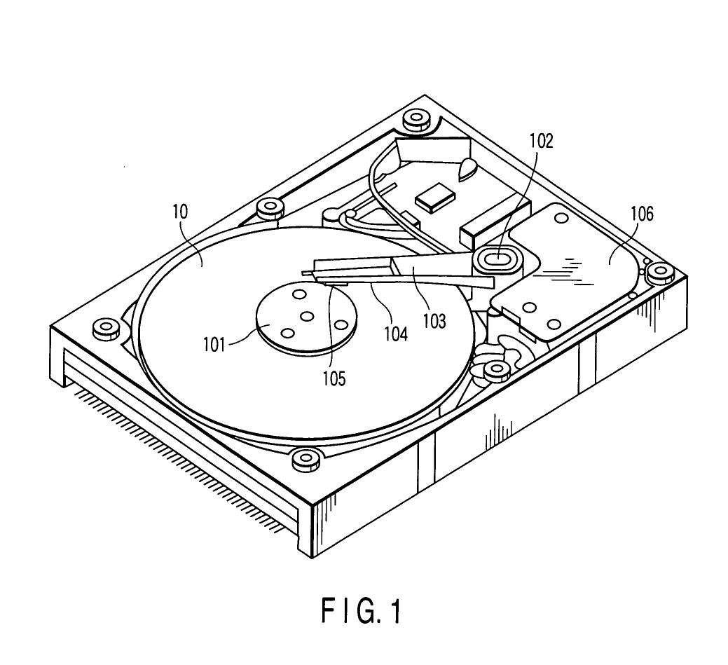

FIG. 1 shows a perspective view of a magnetic recording apparatus according to an embodiment of the invention. A magnetic disc (magnetic recording media) 10 is a so-called patterned media having, for example, a 2.5-inch diameter on which a magnetic recording layer is formed in a region from a 16-mm radius to a 30-mm radius. Recording track regions and separation regions separating the recording track regions are formed concentrically and alternately in the magnetic recording layer. By way of example, the width of the recording track region in the radial direction is set to 100 nm and the width of the separation region in the radial direction is set to 50 nm. The recording track region includes recording cells of magnetic dots arrayed in a down-track direction and forming plural rows in a cross-track direction, and a nonmagnetic layer filled in recesses between the recording cells. The recording cell may be formed in, for example, a cylindrical shape having a diameter of approximately 20 nm. The separation region is formed of a nonmagnetic layer. Grooves recessed by 2 to 10 nm with respect to the surface of the nonmagnetic layer in the recording track regions are formed on the surface of the nonmagnetic layer in the separation regions. A protective film made of diamond-like carbon is formed on the magnetic recording layer and a lubricant is applied to the protective film.

The magnetic disk 10 is mounted on a spindle 101, and is rotated by the motor in response to control signals from a controller. A pivot 102 is provided in the vicinity of the magnetic disc 10. An actuator arm 103 is supported by the pivot 102, a suspension 104 is attached to the tip end of the actuator arm 103, and a head slider 105 is supported on a lower surface of the suspension 104. A magnetic head is incorporated in the head slider 105. The magnetic head includes a write head writing data on the magnetic disc 10 and a read head reading data from the magnetic disk 10. A voice coil motor 106 is provided at a proximal end of the actuator arm 103. The actuator arm 103 is pivotally rotated by the voice coil motor 106 so as to load/unload the magnetic head with respect to the magnetic disk 10. When the magnetic disk 10 is rotated, the head slider 105 flies above the surface of the magnetic disk 10 with a prescribed flying height, and read/write of the data are carried out by the recording head.

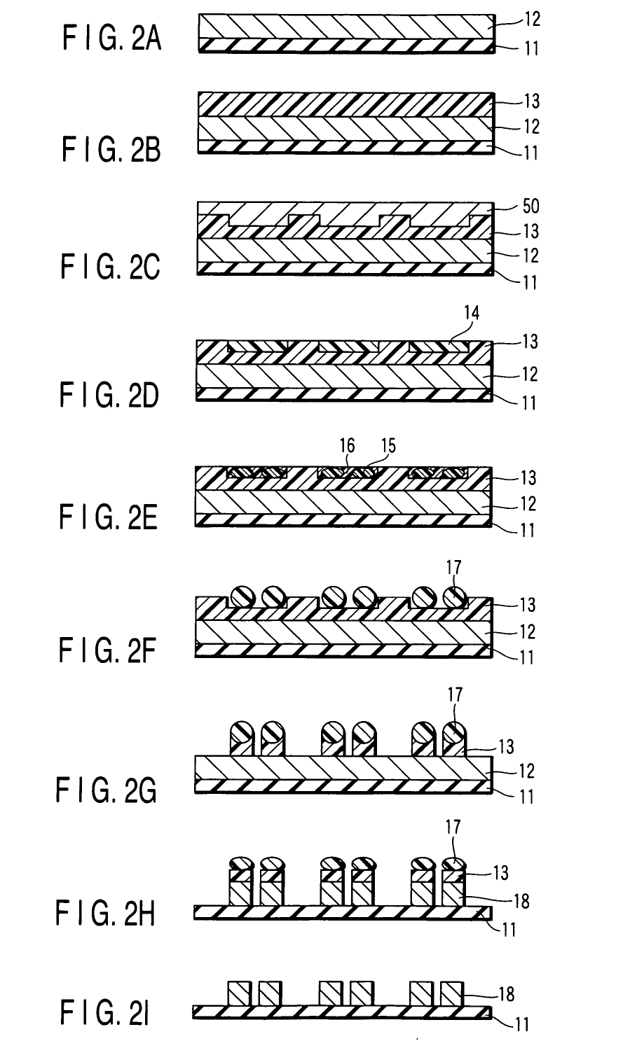

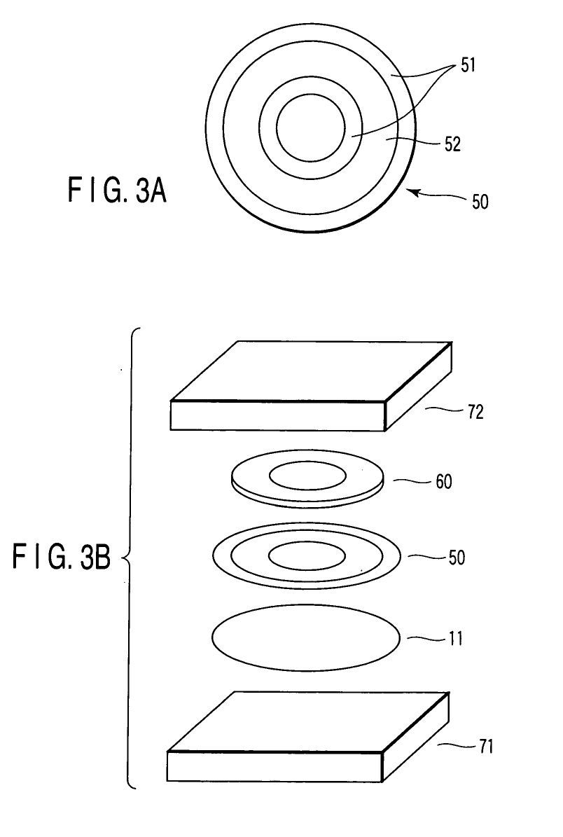

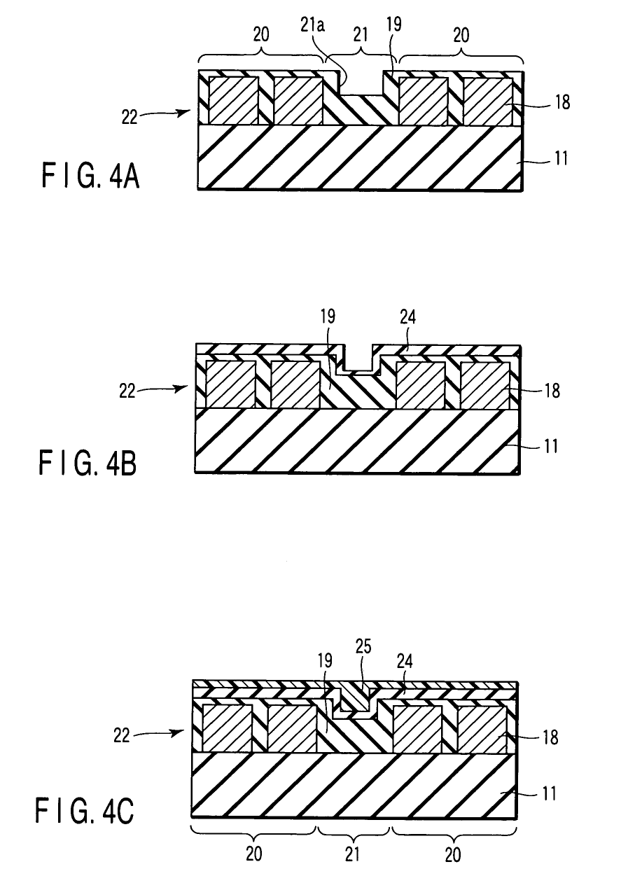

A method of manufacturing the patterned media according to the embodiment of the invention will be described with reference to FIGS. 2A, 2B, 2C, 2D, 2E, 2F, 2G, 2H, and 2I, FIGS. 3A and 3B as well as FIGS. 4A, 4B and 4C.

As shown in FIG. 2A, a Pd under layer (not shown) with a thickness of about 20 nm and a ferromagnetic layer 12 having perpendicular magnetic anisotropy and made of FePt with a thickness of about 30 nm are deposited on a 2.5-inch glass substrate 11. As shown in FIG. 2B, a resist 13 is applied to the ferromagnetic layer 12. As shown in FIG. 2C, a stamper 50 is pressed on the resist 13 by imprinting, and the protrusions and recesses of the stamper 50 are transferred to the resist 13.

As shown in FIG. 3A, the stamper 50 has flat regions 51 having no patterns at the inner periphery and outer periphery, and a patterned region 52 having the protrusions and recesses between the flat regions (in the region from a 16-mm radius to a 30-mm radius). The patterned region 52 includes has protrusions corresponding to the recording track regions of the patterned media and recesses corresponding to the separation regions of the patterned media. The stamper 50 is manufactured in the following manner: A resist is applied to a master plate and patterned by electron beam lithography, a Ni seed film is deposited by sputtering, a Ni electroformed film is deposited by electroforming, and then the Ni electroformed film is peeled off.

As shown in FIG. 3B, the patterns of protrusions and recesses of the stamper 50 are transferred to the resist 13 by imprinting. That is, the glass substrate 11 (on which the ferromagnetic layer 12 and the resist 13 have been formed) is placed on a lower pressing plate 71, the stamper 50 is placed thereon so as to face the surface of protrusions and recesses to the glass substrate 11, and a washer 60 is placed thereon. The stack is pressed by an upper pressing plate 72 at a predetermined pressure.

As shown in FIG. 2D, the stamper 50 is removed after the pressing, whereby the resist 13 to which the patterns of protrusions and recesses are transferred is formed. As a result, recesses corresponding to the recording track regions of the patterned media are formed. As shown in FIG. 2E, the substrate 11 is spin-coated with polystyrene-polymethylmetacrylate (PS-PMMA) diblock copolymer 14 so as to fill in the recesses corresponding to the recording track regions. The diblock copolymer 14 is subjected annealing to be phase-separated, by which PMMA particles 15 and a polystyrene portion 16 surrounding the PMMA particles 15 are formed. As shown in FIG. 2F, PMMA particles 15 are selectively etched by O₂-RIE to form recessed portions. The substrate is spin-coated with spin-on glass (SOG) 17 so as to fill in the recessed portions from which the PMMA particles have been removed. As shown in FIG. 2G, the resist 13 is patterned by the O₂-RIE using the SOG 17 as a mask. As shown in FIG. 2H, the ferromagnetic layer 12 is patterned by ion milling so as to form recording cells 18 formed of isolated cylindrical magnetic dots. As shown in FIG. 2I, ashing is performed to remove the resist residue and the SOG residue thereon. The recording cells 18 are formed so as to be arrayed in the down-track direction and forming plural rows in the cross-track direction in the recording track regions.

Next, as shown in FIG. 4A, spin-on glass (SOG) is used as a precursor of the nonmagnetic layer 19 to be filled in the recesses between the recording cells 18 in recording track regions 20 and the separation regions 21 to thereby form a magnetic recording layer 22 as described below. The spin-on glass is a silicon compound represented by the general formula RₙSi(OH)₄₋ₙ. When SOG is diluted with methanol or ethyl lactate from about three times to about five times, resultant solution can be adjusted to a suitable viscosity. The substrate is spin-coated with the SOG solution for about 40 seconds with a spin coater adjusted to a rotating speed of 2500 to 4000 rpm, and then it is annealed at temperatures from 200 to 300° C. At this time, the surface of the nonmagnetic layers 19 in the separation region 21 can be made lower than the surface of the nonmagnetic layer 19 in the recording track regions 20 by adjusting the viscosity of the SOG solution, the rotating speed of the spin coater and the thickness of the nonmagnetic layer (SOG) 19 left on the recording cells 18. In this manner, the depth of the grooves 21a formed on the surface of the separation regions 21 can be adjusted to a range from 2 to 10 nm, leading to a surface with appropriate roughness. Subsequently, as shown in FIG. 4B, diamond-like carbon is deposited on the surface of the nonmagnetic layer 19 to form a protective film 24. Further, as shown in FIG. 4C, the entire surface is coated with a lubricant 25. As a result, a substantially flat surface is formed on the entire surface in a state that the grooves 21a in the separation regions 21 are filled with the lubricant 25.

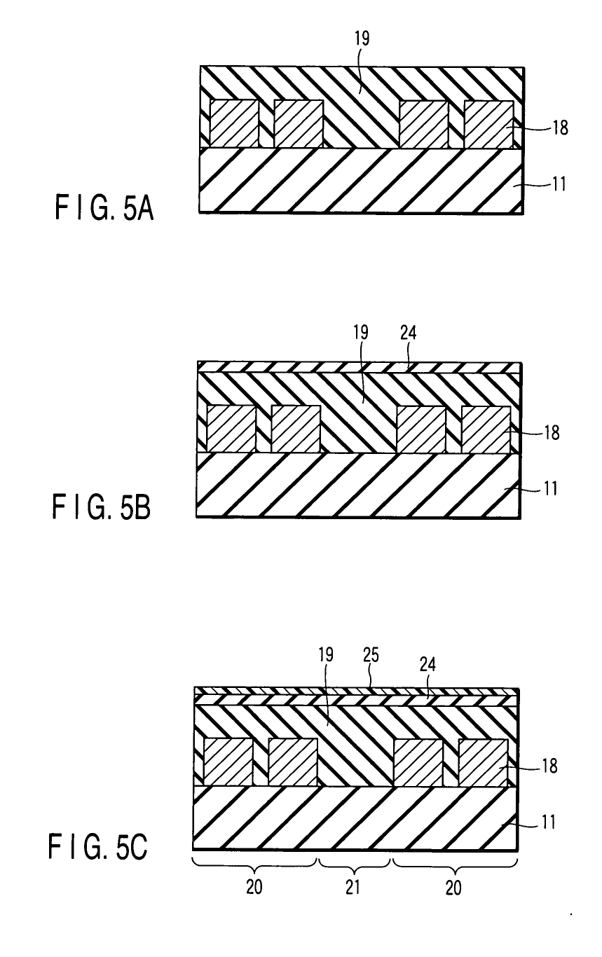

On the other hand, FIGS. 5A, 5B and 5C show a method of manufacturing a patterned media corresponding to a comparative example of the invention. FIGS. 5A, 5B and 5C are views corresponding to FIGS. 4A, 4B and 4C, respectively. As shown in FIG. 5A, when a thick spin-on glass (SOG) used as the precursor of the nonmagnetic layer 19 is formed from the state shown FIG. 2I, the surface of the nonmagnetic layer 19 becomes flat. Thereafter, as shown in FIG. 5B, diamond-like carbon is deposited on the surface of the nonmagnetic layer 19 to form a protective film 24, and, as shown in FIG. 5C, the entire surface is coated with a lubricant 25.

In this example, media 1-1 to 1-5 were formed in which the thickness of the nonmagnetic layer (SOG) 19 on the recording cells 18 and the depth of the grooves on the surface of the nonmagnetic layer 19 in the separation regions 21 are adjusted, as shown in Table 1 below, by controlling the conditions for filling step using SOG shown in FIG. 4A or 5A. The surface roughness (Ra) for each media is also given in Table 1.

Magnetic recording apparatuses incorporating the respective media were manufactured. Tests for flying stability of the head as well as read/write (R/W) tests were carried out.

In the flying stability tests, an acoustic emission (AE) sensor was attached to the head slider, the head slider was allowed to fly above the media at a radial position of 20 mm, and the vibration generated when the head contacted the media was converted into an electric signal which was observed with use of an oscilloscope. The observation was carried out for one hour from the start of flying.

In the R/W tests, a read signal-to-noise ratio SNR (dB) was measured 5 minutes after start of flying for apparatuses in which the head slider exhibited good flying stability above the media.

In addition, linear analysis was performed in several portions with a length of 500 nm to 1 μm along the radial direction of the media by Auger spectroscopy to measure the percentage (%) of lubricant (or fluorine as a component of the lubricant) collected in the grooves.

TABLE 1

| | | | | | | Percentage of |
|---|---|---|---|---|---|---|
| | Thickness of | | | | | lubricant |
| | SOG on | Depth of | | | | collected in |
| | recording cell | groove | Ra | Flying | SNR | grooves |
| | [nm] | [nm] | [nm] | stability | [dB] | [%] |
| 1-1 | 100 | 0 | 0.4 | no good | <10 | — |
| 1-2 | 5 | 2 | 2 | good | 16 | 71 |
| 1-3 | 5 | 5 | 6 | good | 18 | 78 |
| 1-4 | 5 | 10 | 10 | good | 20 | 88 |
| 1-5 | 5 | 12 | 12 | no good | — | |

The media 1-1, in which the SOG on the recording cell had a thickness of about 100 nm, had a substantially flat surface where Ra was 0.4 nm. In the magnetic recording apparatus provided with this media, the head contacted the media at 10 minutes after the start of flying and was made impossible to fly any more. When the head slider was removed from the magnetic recording apparatus after the flying test and was observed with an optical microscope, it was found that the lubricant and carbon protective film which were shaved off from the media were adhered to the head slider.

The media 1-5, in which the SOG on the recording cell had a thickness of about 5 nm and the depth of the groove was 12 nm, had a comparatively rough surface where Ra was 12 nm. In the magnetic recording apparatus provided with this media, the head contacted the media at 10 minutes and 15 minutes after the start of flying, and the head crashed 25 minutes later.

To the contrary, each of the media 1-2 to 1-4 in which the SOG on the recording cell had a thickness of about 5 nm and the depth of the groove was in the range of 2 to 10 nm, had a surface with moderate roughness where Ra was in the range of 2 to 10 nm. In each of the magnetic recording apparatuses provided with these media, respectively, the head did not contact the media with stable flying over a period of 1 hour. These media exhibited a favorable SNR as the groove was deeper. In this manner, the media having grooves on the nonmagnetic layer in the separation regions exhibited more favorable R/W characteristics since the head was not stuck to the media and flied stably.

### Example 2

Using the similar processes to those in Example 1, recording track regions with a width of 100 nm and separation regions with a width of 50 nm were formed alternately in the region from a 16-mm radius to a 30-mm radius on a 2.5-inch glass substrate, recording cells of magnetic dots with a diameter of 20 nm were formed in the recording track regions, and spin-on glass (SOG) used as the nonmagnetic layer was filled in the recesses. The thickness of the nonmagnetic layer (SOG) left on the recording cells was set to 5 nm, and the depth of the groove in the separation regions was set to 2 nm, 5 nm or 10 nm (media 2-1, 2-2 and 2-3, respectively). Thereafter, the entire surface of the nonmagnetic layer (SOG) was etched over 10 nm by ion milling using N₂ gas or reactive ion etching using Ar gas. At this time, the nonmagnetic layer (SOG) was evenly etched on the recording track regions and on the separation regions. As a result, in the recording track regions, the height of the surface of the nonmagnetic layer (SOG) with respect to the surface of the recording cells became −5 nm, i.e., the recording cells protruded by 5 nm from the surface of the nonmagnetic layer. The depth of the grooves on the separation regions was maintained. Thereafter, diamond-like carbon was deposited on the entire surface to form a protective film, and the entire surface was coated with a lubricant.

Like Example 1, magnetic recording apparatuses incorporating the respective media were manufactured, and the flying stability tests for the head, read/write (R/W) tests, and measurements of the percentage of the lubricant (fluorine) collected in the grooves were carried out. The results are shown in Table 2 below.

TABLE 2

| | | | | | | Percentage of |
|---|---|---|---|---|---|---|
| | Height of SOG | | | | | lubricant |
| | surface to | Depth of | | | | collected in |
| | recording cell | groove | Ra | Flying | SNR | grooves |
| | [nm] | [nm] | [nm] | stability | [dB] | [%] |
| 2-1 | −5 | 2 | 2 | good | 18 | 70 |
| 2-2 | −5 | 5 | 6 | good | 20 | 78 |
| 2-3 | −5 | 10 | 10 | good | 22.5 | 86 |

In the magnetic recording apparatuses in which the media 2-1 to 2-3 were incorporated, stable flying was attained for 1 hour without head contact to the media. In addition, as is apparent by comparing Table 2 with Table 1, the SNR was improved by about 2 dB by appropriately etching the surface of the nonmagnetic layer.

### Example 3

In this example, patterned media were manufactured also using the similar processes to those in Example 1, while the width of the recording track region, the width of the separation region, and the ratio of both width were varied as shown in Table 3 below (media 3-1 to 3-6). For all the media, the thickness of the SOG on the recording cell was set to 5 nm and the depth of the groove was set to 5 nm.

Like Example 1, magnetic recording apparatuses incorporating the respective media were manufactured, and the flying stability tests for the head, read/write (R/W) tests, and measurements of the percentage of the lubricant (fluorine) collected in the grooves were carried out. It should be noted that the percentage (%) of the lubricant (fluorine) collected in the grooves was measured by performing linear analysis in several portions with a length of 200 nm to 2 μm along the radial direction of the media by Auger spectroscopy. The results are shown in Table 3 below.

TABLE 3

| | | | | | | Percentage of |
|---|---|---|---|---|---|---|
| | Width of | | | | | lubricant |
| | recording | Width of | | | | collected in |
| | track region | separating | | Flying | SNR | grooves |
| | [nm] | region [nm] | Ratio | stability | [dB] | [%] |
| 3-1 | 500 | 50 | 10:1 | good | 16 | 88 |
| 3-2 | 250 | 50 | 5:1 | good | 16 | 86 |
| 3-3 | 100 | 50 | 2:1 | good | 16 | 78 |
| 3-4 | 50 | 50 | 1:1 | good | 16 | 76 |
| 3-5 | 1000 | 50 | 20:1 | no good | <10 | 89 |
| 3-6 | 750 | 50 | 15:1 | no good | <10 | 89 |

In the magnetic recording apparatuses incorporating the media 3-1 to 3-4 in which the ratios of the width of the recording track region to the width of the separation region were 10:1, 5:1, 2:1 and 1:1, respectively, stable flying was attained for 1 hour without head contact to the media.

In the magnetic recording apparatus incorporating the media 3-5 and 3-6 in which the ratios of the width of the recording track region to the width of the separation region were 20:1 and 15:1, respectively, flying stability of the head was unfavorable and the read/write (R/W) characteristics were also poor.

In this manner, when the ratio of the width of the recording track region to the separation region was set to the range from 10:1 to 1:1, good flying stability of the head and favorable R/W characteristics were provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A magnetic recording media comprising:
a magnetic recording layer comprising: recording track regions including recording cells of magnetic dots arrayed in a down-track direction and forming plural rows in a cross-track direction, and a nonmagnetic layer filled in recesses between the recording cells, and separation regions of a nonmagnetic layer, separating the recording track regions; and a lubricant applied to a surface of the magnetic recording layer, wherein grooves are formed on a surface of the nonmagnetic layer in the separation regions so as to be recessed by 2 to 10 nm with respect to a surface of the nonmagnetic layer in the recording track regions, and wherein the lubricant is applied to the surface of the magnetic recording layer so as to be filled in the grooves.

2. The magnetic recording media according to claim 1, wherein the surface of the nonmagnetic layer in the recording track regions has a height within a range between a position higher by 10 nm and a position lower by 5 nm with respect to a surface of the recording cells.

3. The magnetic recording media according to claim 1, wherein the separation region has a width from 5 to 100 nm, and a ratio of a width of the recording track region to the width of the separation region ranges from 10:1 to 1:1.

4. The magnetic recording media according to claim 1, wherein the nonmagnetic layer is formed of spin-on-glass.

5. The magnetic recording media according to claim 1, further comprising a protective layer formed of carbon between the magnetic recording layer and the lubricant.

6. A method of manufacturing a magnetic recording media comprising:
depositing a magnetic layer on a substrate;
patterning the magnetic layer into magnetic dots to form recording cells arrayed in a down-track direction and forming plural rows in a cross-track direction so as to form recording track regions;
coating the substrate with a precursor solution of a nonmagnetic layer so as to be filled in recesses between the recording cells and separation regions between recording track regions;
annealing the precursor solution to form the nonmagnetic layer having grooves on a surface thereof in the separation regions which are recessed by 2 to 10 nm with respect to a surface thereof in the recording track regions so as to form a magnetic recording layer; and applying a lubricant to a surface of the magnetic recording layer so as to be filled in the grooves.

7. The method according to claim 6, wherein the surface of the nonmagnetic layer in the recording track regions has a height within a range between a position higher by 10 nm and a position lower by 5 nm with respect to a surface of the recording cells.

8. The method according to claim 6, wherein the separation region has a width from 5 to 100 nm, and a ratio of a width of the recording track region to the width of the separation region ranges from 10:1 to 1:1.

9. The method according to claim 6, wherein the nonmagnetic layer is formed of spin-on-glass.

10. The method according to claim 6, further comprising forming a protective layer formed of carbon on the magnetic recording layer.

11. A magnetic recording apparatus comprising:
the magnetic recording media according to claim 1; and a magnetic head.
